(19) United States
(12) Patent Application Publication
(10) Pub. No.: US 2008/0268404 A1
(43) Pub. Date: Oct. 30, 2008

(54) Novel Aircraft Training Platform and Related Method of Operation

(76) Inventor: Rick Burt, (US)

Correspondence Address: Burman Mathis, 17814 Fairlady Way, Germantown, MD, 20874, US

(21) Appl. No.: 11/863,091

(22) Filed: Sep. 27, 2007

Related U.S. Application Data
(60) Provisional application No. 60/847,364, filed on Sep. 27, 2006.

(51) Int. Cl. G09B 9/12

(52) U.S. Cl. 434/55

(57) ABSTRACT

Various methods and systems are disclosed. For example, a training apparatus includes a moveable platform configured to allow an operating aircraft to land upon it, a set of actuators mechanically coupled to the platform to cause the platform to be controllable moved in a plurality of degrees of freedom. Control circuitry may be coupled to the set of actuators, the control circuitry configured to cause the moveable platform to move according to a simulated environment.

This Application claims priority to U.S. Provisional Patent Application No. 60/847,364 to Mr. Rick Burt filed on Sep. 27, 2006 entitled “Novel Training Platform and Related Method of Operation”. The contents of the above-reference Provisional Application are incorporated by reference in their entirety for all purposes.

### BACKGROUND

I. Field

The following description relates generally to systems and methods for training pilots.

II. Background

Historically, the art of flying a helicopter has been learned by some amount of academic education combined with a massive amount of practical training and experience.

Often, training starts in some form of conventional simulator where a pilot sits in a safe environment where the pilot interacts with a set of imitation helicopter controls. As the pilot interacts with the controls, a set of sensors coupled to the controls will monitor the forces applied by the pilot. In turn, a complex set of control programs will use the output of the various sensors to approximate those changes of states that a normal helicopter would experience. In response to the control programs, a set of hydraulic actuators will move the bulk of the simulator to simulate the actual motion a pilot would normally feel.

Unfortunately, such simulated environments do not provide the robust experience needed for many situations a pilot may encounter. On the other hand, the actual experience of such situations can be so hazardous for an inexperienced pilot that many helicopter crews may be injured or lost and/or their aircraft damaged or destroyed.

Accordingly, new technologies directed to improving pilot training are may be useful.

### SUMMARY

Various aspects and embodiments of the invention are described in further detail below.

In an embodiment, a training apparatus includes a moveable platform configured to allow an operating aircraft to land upon it, a set of actuators mechanically coupled to the platform to cause the platform to be controllable moved in a plurality of degrees of freedom, and control circuitry coupled to the set of actuators, the control circuitry configured to cause the moveable platform to move according to a simulated environment.

In another embodiment, a training apparatus includes a moveable platform configured to allow an operating aircraft to land upon it, a first means coupled to the platform for causing the platform to be controllable moved in a plurality of degrees of freedom, and a control means coupled to the set of actuators, the control means for causing the moveable platform to move according to a simulated environment.

### BRIEF DESCRIPTION OF THE DRAWINGS

The features and nature of the present disclosure will become more apparent from the detailed description set forth below when taken in conjunction with the accompanying drawings in which reference characters identify corresponding items.

FIG. 1 depicts an exemplary helideck simulator platform in an outdoor environment along with an observation post.

FIG. 2 depicts a first exemplary embodiment for the helideck simulator platform capable of seven degrees of freedom.

FIG. 3 depicts a first exemplary embodiment for the helideck simulator platform capable of seven degrees of freedom.

FIGS. 4-7 are performance diagrams for a number of exemplary embodiments of the disclosed methods and systems.

FIG. 8 is a block diagram of an exemplary control system for the helideck simulator platform of FIG. 1

FIG. 9 is a flowchart outlining an exemplary operation of the disclosed methods and systems.

### DETAILED DESCRIPTION

The disclosed methods and systems below may be described generally, as well as in terms of specific examples and/or specific embodiments. For instances where references are made to detailed examples and/or embodiments, it should be appreciated that any of the underlying principals described are not to be limited to a single embodiment, but may be expanded for use with any of the other methods and systems described herein as will be understood by one of ordinary skill in the art unless otherwise stated specifically.

Piloting of any sort is an inherently dangerous occupation, and it may be impossible to remove all risk for even the most mundane of environments. However, there are certain situations that are considered notoriously dangerous even for the most experienced of pilots.

Among such situations are helicopter deck (“helideck”) landings at sea where a helicopter pilot may be required to land his aircraft on a relatively small platform at the back of a ship that may be tossing and turning in response to rough seas.

While such situations may be simulated in conventional simulators, such simulations have limited usefulness. Further, “on-the-job” experience can be so hazardous that lives are lost and aircraft destroyed every year as even the most experienced of pilots may have limited experience with different seagoing conditions.

In response to this situation, the following methods and systems were developed to enable a new form of training where a pilot, flying the helicopter of choice, can practice landings and takeoffs using a platform controlled in a way that simulates the motion of a helideck platform in any number of seagoing conditions.

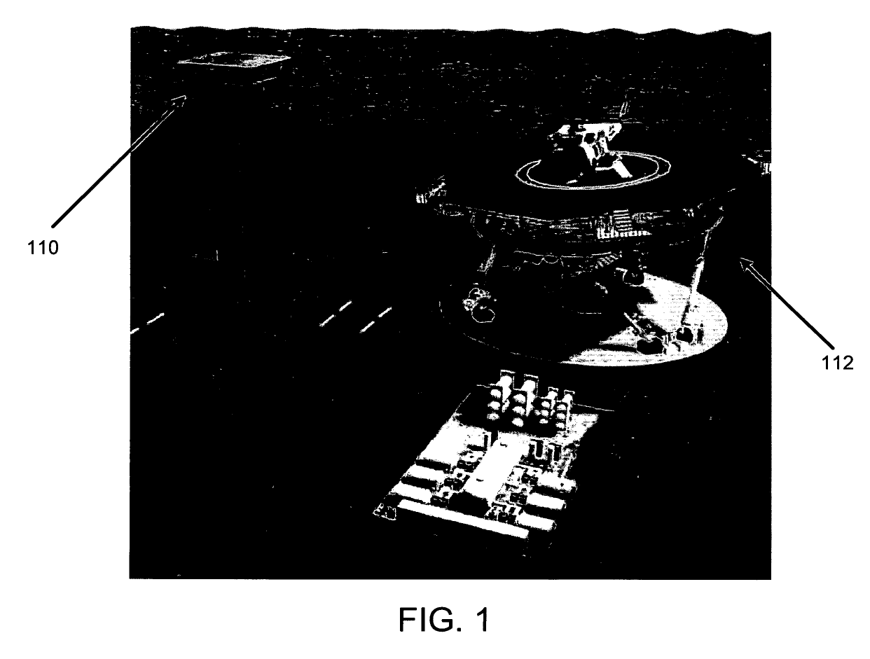

FIG. 1 depicts an exemplary simulated helideck platform 112 in an outdoor environment along with an observation post 110. In operation, the simulated helideck platform 112 can be made to move about any number of degrees of freedom (DOF), e.g., 3, 4 or 5 DOF, but of course it is to be appreciated that a 6-DOF system capable of simulating a ship's surge, sway, heave, roll, pitch and yaw may be more useful than platforms having fewer degrees of freedom. Of course any increase in performance may come at the expense of greater complexity and costs.

Additionally, in various embodiments in may be useful to include yet another degree of freedom to take advantage of any wind that may be present. That is, in certain seaside locations, such as Newfoundland, Canada, wind can be guaranteed practically any day, but of course the direction of that wind will vary from day to day, hour to hour. Thus, it may be useful to enable the simulated helideck platform 112 to rotate about a central axis and normal to the horizontal plane of the base of the simulated helideck platform 112. By adding such a feature, pilots can practice takeoffs and landings while effectively controlling wind direction for the greatest diversity of training exercises.

In various embodiments, helideck rotation can take place about a full 360 degrees. However, in various embodiments it may be technically easier, yet still effective, to enable rotation about lesser angles, e.g., 270 degrees, 180 degrees or 90 degrees.

Note that, given that the helideck simulation system is located outdoors and used in concert with actual helicopters, it may be beneficial to use actuators far stronger than used in ordinary simulators and having some extra form of corrosion resistance, such as a ceramic coating or other corrosion-resistant materials.

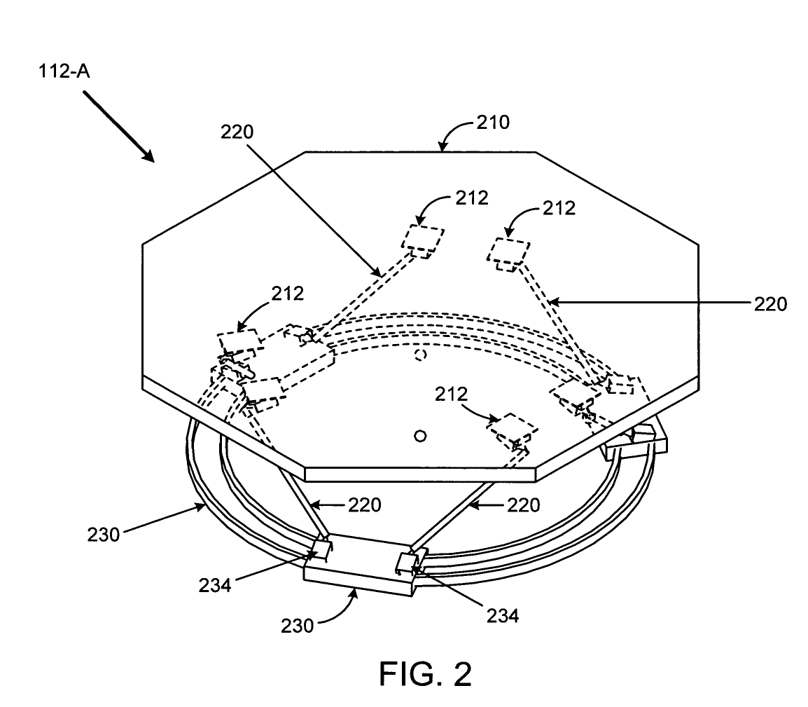

FIG. 2 depicts a first exemplary embodiment 112-A for the helideck simulator platform capable of seven degrees of freedom. As shown in FIG. 2, the first helideck embodiment 112-A includes a moveable platform 210 upon which a helicopter may make contact, a set of circular base rails/drives 230, a set of (six) hydraulic actuators 220 couple to the platform via top pads 212 and coupled to the circular base rails/drives 230 via a set of bottom pads 234 and base supports 230. The present helideck embodiment 112-A is an example of a training system where rotation is made at the base of the system using the circular base rails/drives 230, which can effectively act as a turntable.

In operation, the platform 210 may be made to move about 1-6 degrees of freedom by virtue of the hydraulic actuators 220, which are themselves controlled using hydraulic control systems (not shown) and some form of computer circuitry (also not shown).

While it is certainly possible to perform rotation about the circular base rails/drives 230 at any time, in various embodiments rotation may be limited to times when the hydraulic actuators 220 are not moving and/or set to secure/settled positions. The turntable can then be locked firmly before the actuators are allowed to move (reproducing ship motions). Generally, (but not necessarily) rotation may be accomplished using a skidding system or by using a number of electric or hydraulic motors, and rotation accuracy may be feasible to within +/−1° or less.

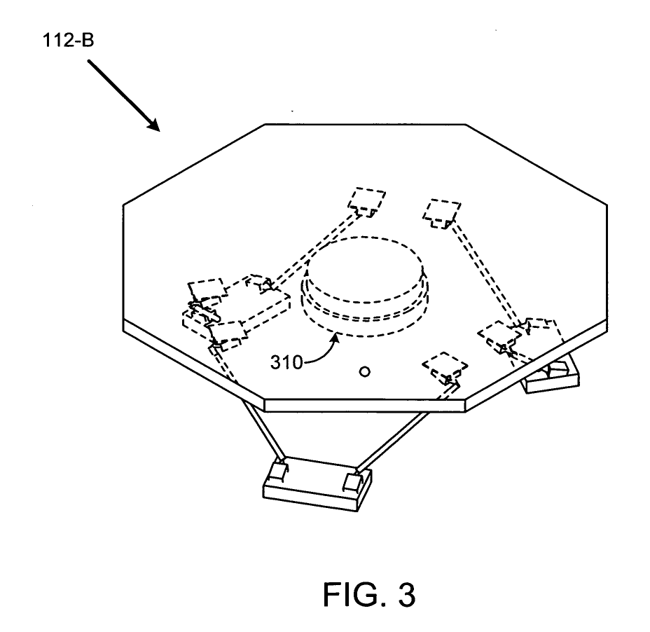

FIG. 3 depicts a second exemplary embodiment 112-B for the helideck simulator platform—again capable of seven degrees of freedom. As shown in FIG. 3, the second helideck embodiment 112-B is similar to the first helideck embodiment 112-A of FIG. 2, but altered in a way such that rotation is made at the top of the system using a turntable device 310 located just under the platform 210.

For calculations of the motion system it is important to choose one principle (top or bottom rotation) in an early development stage since this choice affects the forces on the actuators 220, i.e., the weight supported by the actuators in second helideck embodiment 112-B may be substantially greater. For example, according to one set of calculations for specific embodiments, the minimum static force against the actuators for the first helideck embodiment 112-A may be about 89,000 lbs while the minimum static force against the actuators for the second helideck embodiment 112-B may be about 99,000-102,000 lbs.

Continuing, some consideration of the simultaneous and non-simultaneous velocities and accelerations of a landing platform may be taken into account in order to fully reproduce realistic helideck movements. The derived velocities and accelerations are not included in this document, but are fully within the capacity of one of ordinary skill in the art to derive.

Various issues to be considered include: (1) the length of the cushioning zone of the actuators, (2) the available hydraulic Power, (3) the size of hydraulic components (valves, piping, hoses, etc.), and (4) simultaneous heave and pitch velocities.

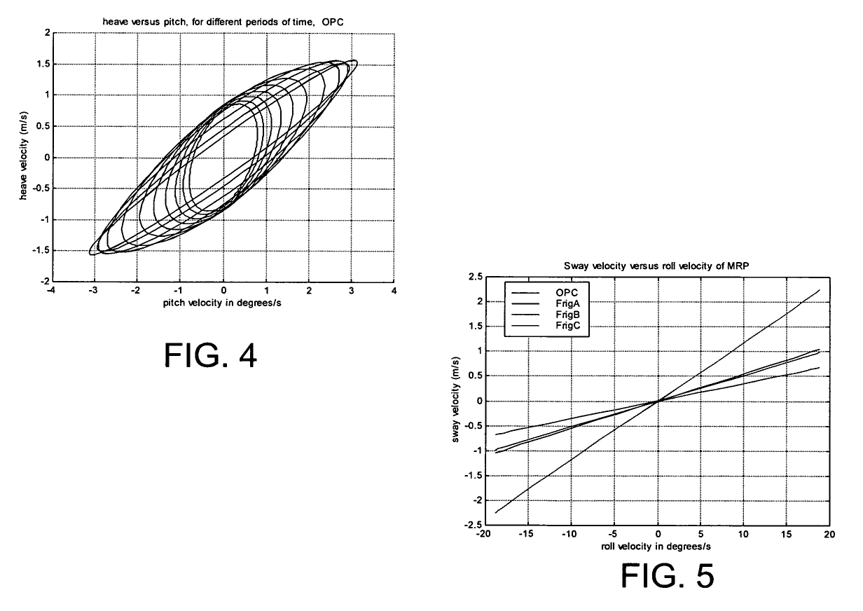

For various ocean/water wave frequencies (T=5 . . . 15s), the heave-velocity versus pitch-velocity coupling of a helideck platform is calculated and plotted in 4. In view of FIG. 4, it is useful to design a motion base to generate the “velocity workspace” plotted as a series of ellipticals. High frequency motions are represented by the long and narrow ellipses. Lower frequent motions are represented by the wider shorter ellipses. For the present embodiment, the maximum simultaneous velocity requirement of the platform is 1.57 m/s of heave together with 3.2 deg/s pitch.

Next, with regard to simultaneous roll and sway velocities, attention is drawn to FIG. 5. Roll velocity depends on the roll frequency and amplitude. For roll motions, it may be assumed that the period time of the sinusoidal ship movements shall not be lower than 5 seconds and the amplitude shall not exceed 15°. For the present embodiment, the maximum lateral velocity requirement of the platform is 2.25 m/s of sway together with 19°/s roll.

For non-simultaneous motions the following is assumed: The non-simultaneous velocities and accelerations in rotational directions are based on a reference wave with a wave period of approximately 5 seconds. It is also assumed that this wave pattern results in a movement of maximum single rotational degree of freedom excursions. The linear velocities are selected at 2.0 m/s, and overall non-simultaneous velocities may be found in Table 1 below:

TABLE 1
Non-Simultaneous velocities
Non-simultaneous velocities

| Direction | Velocity |
|---|---|
| Surge | +/−2 m/s |
| Sway | +/−2 m/s |
| Heave | +/−2 m/s |
| Roll | +/−19°/s |
| Pitch | +/−19°/s |
| Yaw | +/−19°/s |

Continuing,

Table 2 is an exemplary set of actuator velocities for a system using six actuators. Actuator velocities are calculated for simultaneous and non-simultaneous motions.

Table 2 shows that the largest actuator velocity (2.251 m/s) appears during the non-simultaneous roll or simultaneous motion.

TABLE 2
Actuator velocities

| | Actuator velocities | | | | | | | |
|---|---|---|---|---|---|---|---|---|
| | Non-simultaneous | | | | | | Simultaneous | |
| | Surge | Sway | Heave | Roll | Pitch | Yaw | Vertical | Lateral |
| Actuator# | [m/s] | [m/s] | [m/s] | [m/s] | [m/s] | [m/s] | [m/s] | [m/s] |
| 1 | 0.604 | −1.046 | −1.594 | −0.449 | 2.339 | −1.705 | −0.870 | −1.626 |
| 2 | −1.208 | 0 | −1.594 | −2.251 | −0.781 | 1.705 | −1.379 | −2.251 |
| 3 | 0.604 | 1.046 | −1.594 | −1.801 | −1.559 | −1.705 | −1.506 | −0.625 |
| 4 | 0.604 | −1.046 | −1.594 | 1.801 | −1.559 | 1.705 | −1.506 | 0.625 |
| 5 | −1.208 | 0 | −1.594 | 2.251 | −0.781 | −1.705 | −1.379 | 2.251 |
| 6 | 0.604 | 1.046 | −1.594 | 0.449 | 2.339 | 1.705 | −0.870 | 1.626 |

Continuing, the following is a discussion of simultaneous and non-simultaneous acceleration requirements of a exemplary motion base. The simultaneous and non-simultaneous acceleration requirements will mainly be used (in further analyses) to determine the nominal actuator force and nominal forces on floor pads/joints.

Also the worst case accelerations due to a failure in controls (Valve zero, or cushioning) are described. The worst case accelerations will be mainly be used to determine the worst case forces on floor pads and joints.

For various wave frequencies (T=5 . . . 15s), exemplary heave-velocity versus pitch-velocity coupling is calculated and plotted in FIG. 5. A suitable motion base is one designed to generate the “acceleration workspace” of FIG. 5.

The wide and long ellipses represent the high frequent motions. The lower frequent motions are represented by the small and shorter ellipses. Maximum simultaneous acceleration requirement of the present embodiment is approximately 4 m/s² heave together with 2°/s² pitch.

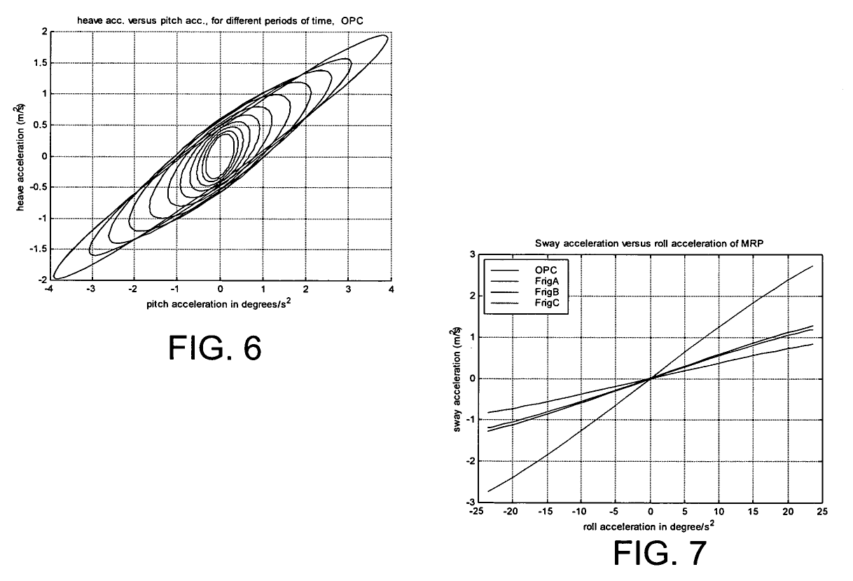

Continuing, roll acceleration depends on the roll frequency and amplitude. It is assumed in the present embodiment that the period time of the roll shall not be lower than 5 seconds and that the roll amplitude shall not exceed 15°. In FIG. 6, Sway-roll coupling is given with respect to the platform, and the maximum simultaneous acceleration is 24°/s² roll together with 2.85 m/s² sway for the present embodiment.

For the non-simultaneous motions the following is assumed: The nominal non-simultaneous velocities and accelerations in rotational directions are based on a reference wave with a wave period of approx. 5 seconds. It can be further assumed that this wave pattern results in a movement of maximum single rotational degree of freedom excursions. This will result in an acceleration of 0.25 g. Considering wave patterns, which may exist in a broad spectrum, higher wave periods can occur. Therefore the linear accelerations are selected at 0.5 g.

TABLE 3
Non-simultaneous accelerations
Non-simultaneous accelerations

| Direction | Acceleration |
|---|---|
| Surge | +/−0.5 g |
| Sway | +/−0.5 g |
| Heave | +/−0.5 g |
| Roll | +/−24°/s² |
| Pitch | +/−24°/s² |
| Yaw | +/−30°/s² |

Continuing, in

Table 4, exemplary accelerations of the six actuators are calculated for simultaneous and non-simultaneous motions.

Table 4 shows that the largest actuator acceleration (±3.99 m/s²) appears during the non-simultaneous heave motion.

TABLE 4
Actuator Accelerations

| | Actuator acceleration | | | | | | | |
|---|---|---|---|---|---|---|---|---|
| | Non-simultaneous | | | | | | Simultaneous | |
| | Surge | Sway | Heave | Roll | Pitch | Yaw | Vertical | Lateral |
| Actuator# | [m/s²] | [m/s²] | [m/s²] | [m/s²] | [m/s²] | [m/s²] | [m/s²] | [m/s²] |
| 1 | 1.51 | −2.61 | −3.99 | −0.57 | 2.95 | −2.69 | −1.1 | −2.03 |
| 2 | −3.02 | 0 | −3.99 | −2.84 | −0.99 | 2.69 | −1.76 | −2.72 |
| 3 | 1.51 | 2.61 | −3.99 | −2.28 | −1.97 | −2.69 | −1.92 | −0.69 |
| 4 | 1.51 | −2.61 | −3.99 | 2.28 | −1.97 | 2.69 | −1.92 | 0.69 |
| 5 | −3.02 | 0 | −3.99 | 2.84 | −0.99 | −2.69 | −1.76 | 2.72 |
| 6 | 1.51 | 2.61 | −3.99 | 0.57 | 2.95 | 2.69 | −1.1 | 2.03 |

Worst case accelerations of a platform may occur due to failure(s) in one or more of the actuators. During a failure the actuator can generate higher forces than that the motion base requires nominally, which results in significant higher acceleration than the nominal accelerations:

In general, two types of extreme forces can cause extreme accelerations of the payload including:

Worst case forces: This is the maximum force that can occur during a failure (cushioning, valve null etc.). Reaction forces of the six upper pads are calculated when one actuator loads its upper pad with the maximum force, while the other five actuators are locked (no acceleration, no velocity). All possible system positions (64 combinations of extended and retracted actuators) are investigated to find the extreme resulting forces on the upper pads. The results are shown in

Table 5. These results do not include a safety factor. In retracted position the actuator loads the upper pad with 1967 kN pushing. Totally extended, the actuator loads the upper pad with 1441 kN pulling. Two cases are considered, including when a helicopter is at an extreme position on deck and when the helideck is empty

Maximum Nominal Force: These values are theoretical values that are calculated using the maximum nominal force that the actuators can generate. During normal simulation (normal mode), these values are limited by software. During operation in manual mode, certain test signals (for instance step response) may generate these accelerations. These values do not include the normal gravity acceleration. In neutral the system is optimal compensated, i.e., not static force. The nominal cylinder force (pressure times surface)=0.0346*180 bar=623 kN.

The extreme accelerations the specified loading conditions are summarized in

Table 5. The last column shows the maximum extreme accelerations of the column 2 to 4. The accelerations in the last column are design parameters for the helideck (payload).

TABLE 5
Worst case accelerations of the MRP
Worst case acceleration of the MRP

| | Acc. due to worst case | Acc. due to worst case | Acceleration due | |
|---|---|---|---|---|
| | loading | loading | to max. nominal | Worst case |
| Direction | “Helicopter on deck” | “Empty helideck” | force | acceleration |
| Surge | +/−2.3 g | +/−2.4 g | +/−1.1 g | +/−2.4 g |
| Sway | +/−1.9 g | +/−2.4 g | +/−1.0 g | +/−2.4 g |
| Heave | +/−1.5 g | +/−1.5 g | +/−0.9 g | +/−1.5 g |
| Roll | +/−156°/s² | +/−162°/s² | +/−76°/s² | +/−162°/s² |
| Pitch | +/−130°/s² | +/−152°/s² | +/−74°/s² | +/−152°/s² |
| Yaw | +/−93°/s² | +/−111°/s² | +/−52°/s² | +/−111°/s² |

Continuing, the minimum required non-simultaneous velocities/accelerations of the exemplary platform are summarized below:

TABLE 6
Non-simultaneous velocities/accelerations
Non-simultaneous velocity Requirements

| Direction | Velocity | Acceleration |
|---|---|---|
| Surge | +/−2.0 m/s | +/−0.5 g |
| Sway | +/−2.0 m/s | +/−0.5 g |
| Heave | +/−2.0 m/s | +/−0.5 g |
| Roll | +/−19.0°/s | +/−24°/s² |
| Pitch | +/−19.0°/s | +/−24°/s² |
| Yaw | +/−24.0°/s | +/−30°/s² |

Simultaneous velocities/accelerations can be summarized by:

TABLE 7
Simultaneous velocities/accelerations
Simultaneous requirements

| Coupling | Velocities | Acceleration |
|---|---|---|
| Heave Pitch | 3.2°/s pitch at 1.57 m/s | 2.0°/s² pitch at 4 m/s² |
| | heave −3.2°/s pitch | heave −2.0°/s² pitch |
| | at −1.57 m/s heave | at −4 m/s² heave |
| Sway roll | 19°/s at 2.25 m/s | 24°/s² at 2.85 m/s² |
| | sway −19°/s | sway −24°/s² at −2.85 |
| | at −2.25 m/s sway | m/s² sway |

Worst case accelerations may occur due to failure(s) in one or more of the actuators. During such failure, the actuator can generate higher forces than that the motion base requires nominally, which results in significant higher accelerations of the MRP than the nominal required accelerations.

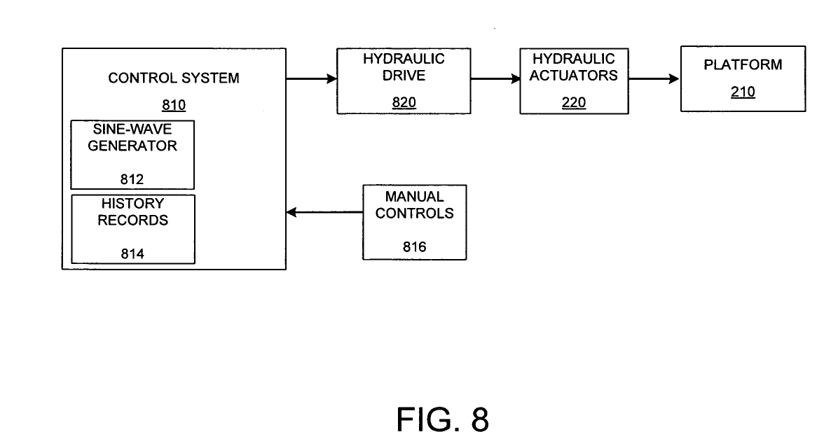

FIG. 8 is a block diagram of an exemplary helideck simulator platform of FIG. 1. As shown in FIG. 8, the block diagram includes a control system 810, a hydraulic drive apparatus 820, a set of hydraulic actuators 220, a platform 210 and an optional set of manual controls 830, such as a joystick, computer keyboard, computer mouse, and so on. The control system 810 includes a sine-wave generator 812 and a set of history/telemetry records 814.

In operation, the control system 810 can be first activate and an appropriate control input selected, such as any of the set of manual controls 830, the sine-wave generator 812 and a set of history/telemetry records 814.

Next, assuming rotation of the relevant helideck platform is made or unnecessary, the hydraulic controls 820 and actuators 220 moving the helideck platform 210 may be activated and used as necessary or desired.

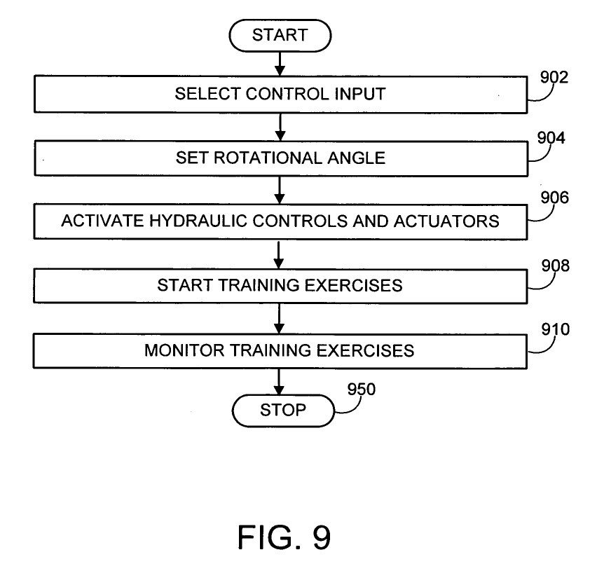

FIG. 9 is a flowchart outlining an exemplary operation of the disclosed methods and systems for the operation of a helideck simulation platform. The process starts in step 902 where the control input for some form of helideck control circuitry may be selected. As discussed above, a control input can take a variety of forms, such as a sinusoid (or other waveform) generator, a history/telemetry record based upon actual measurements taken from a ship at sea under various conditions (e.g., high swells, storm conditions, etc.) an operator using a joystick or other manual controls, and so on.

In step 904, the helideck platform may be rotated to a desired angle, and optionally locked down afterward. Next, in step 906, the hydraulic controls and actuators moving the helideck platform may be activated. Control continues to step 908.

In step 908, a set of training exercises may be performed with the helideck platform moved by the actuators under control of the control circuitry and control input, and in step 910, training may be monitored as desired. Generally, training may include repeatedly landing and taking off based upon at least one set of simulated seagoing conditions and perhaps a variety of simulated conditions. Control then continues to step 950 where the process stops.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A training apparatus for use with human-occupied aircraft, comprising:
a moveable platform configured to allow an operating aircraft to land upon it;
a set of actuators mechanically coupled to the platform to cause the platform to be controllably moved in a plurality of degrees of freedom; and
control circuitry coupled to the set of actuators, the control circuitry configured to cause the moveable platform to move according to a simulated environment.

2. The training apparatus of claim 1, wherein the operating aircraft is capable of vertical landing.

3. The training apparatus of claim 2, wherein the operating aircraft is a helicopter.

4. The training apparatus of claim 1, wherein the control circuitry is configured to move the moveable platform in a manner as to simulate motion of a helicopter deck of a seacraft.

5. The training apparatus of claim 4, wherein the control circuitry is configured to move the moveable platform according to a generally sinusoidal motion in at least one degree of freedom.

6. The training apparatus of claim 4, wherein the control circuitry is configured to move the moveable platform according to a pre-recorded motion history of an operable seacraft undergoing at least one set of seagoing conditions.

7. The training apparatus of claim 6, wherein the control circuitry is configured to move the moveable platform based on a plurality of sets of different recorded seagoing conditions experienced by the seacraft.

8. The training apparatus of claim 4, wherein the moveable platform is capable of at least six degrees of freedom including surge, sway, heave, roll, pitch and yaw.

9. The training apparatus of claim 4, wherein the moveable platform is capable of at least two degrees of freedom including at least a 90 degree rotation about a horizontal plane.

10. The training apparatus of claim 1, wherein the moveable platform is positioned outdoors, and the actuators are configured to resists corrosion consistent with outdoor environments.

11. The training apparatus of claim 10, wherein the actuators are configured so as to employ at least a total force of a hundred thousand pounds of force normal to the surface of the platform.

12. A training apparatus for use with human-occupied aircraft, comprising:
a moveable platform configured to allow an operating aircraft to land upon it;
a first means coupled to the platform for causing the platform to be controllably moved in a plurality of degrees of freedom; and
control means coupled to the set of actuators, the control means for causing the moveable platform to move according to a simulated environment.

13. The training apparatus of claim 12, wherein the control means is configured to move the moveable platform in a manner as to simulate motion of a helicopter deck of a seacraft.

14. The training apparatus of claim 13, wherein the control circuitry is configured to move the moveable platform according to a generally sinusoidal motion in at least one degree of freedom.

15. The training apparatus of claim 13, wherein the control means is configured to move the moveable platform according to a pre-recorded motion history of an operable seacraft undergoing at least one set of seagoing conditions.

16. The training apparatus of claim 13, wherein the moveable platform is capable of at least six degrees of freedom including surge, sway, heave, roll, pitch and yaw.

17. The training apparatus of claim 12, wherein the moveable platform is capable of at least two degrees of freedom including at least a 90 degree rotation about a horizontal plane.

18. A method for training pilots in human-occupied aircraft, comprising:
moving a moveable platform configured to allow an operating aircraft to land upon it based upon a control input, the control input being configured to simulate a variety of seagoing conditions experienced by a seacraft; and
landing at least one helicopter repeatedly on the moveable platform while the moveable platform is moving.

19. The method of claim 18, wherein the step of moving includes moving the moveable platform at least six degrees of freedom including surge, sway, heave, roll, pitch and yaw.

20. The method of claim 19, further comprising rotating the moveable platform by least a 90 degree about a horizontal plane before the step of moving.
